(19) United States
(12) Patent Application Publication
(10) Pub. No.: US 2021/0092222 A1
(43) Pub. Date: Mar. 25, 2021

(54) DEVICE AND METHOD FOR SUGGESTING ACTION ITEM

(71) Applicant: LG ELECTRONICS INC., Seoul (KR)

(72) Inventors: Pil Goo Kang, Seoul (KR); Hyeong Jin Kim, Incheon (KR); Hyung Joo Cheon, Seoul (KR)

(73) Assignee: LG ELECTRONICS INC., Seoul (KR)

(21) Appl. No.: 16/781,933

(22) Filed: Feb. 4, 2020

(30) Foreign Application Priority Data
Sep. 19, 2019 (KR) 10-2019-0115670

(51) Int. Cl. H04M 3/22; G10L 15/26; G06F 16/903; G06F 8/61

(52) U.S. Cl. CPC H04M 3/2218; G06F 8/62; G06F 16/90344; G10L 15/26

(57) ABSTRACT

Disclosed is an action item suggesting method and a terminal. An action item suggesting method comprises converting call data into text; extracting a keyword from text information including a call transcript, text message, and e-mail; and suggesting an action item corresponding to a class by inferring the class to which the keyword belongs. According to the present disclosure, it is possible to suggest an action item by using a deep learning-based neural network through the 5G network.

### CROSS-REFERENCE TO RELATED APPLICATION

Pursuant to 35 U.S.C. § 119(a), this application claims the benefit of earlier filing date and right of priority to Korean Patent Application No. 10-2019-0115670, filed on Sep. 19, 2019, the contents of which are all hereby incorporated by reference herein in their entirety.

### BACKGROUND

### 1. Technical Field

The present disclosure relates to a device and a method for suggesting an action item, and more particularly, to a method for: executing an application related to speech and text information transmitted and received via a means of communication; and suggesting a specific action item, and a device using the method.

### 2. Description of Related Art

A virtual assistant, similar to a personal assistant, refers to a software agent processing a task requested by a user and providing a user-specific service. The virtual assistant provides customized information to the user based on artificial intelligence engines and speech recognition, and perform various tasks such as schedule management, e-mail transmission, and restaurant reservation, according to a speech command of the user. Further, the virtual assistant is installed in various smart home appliances or vehicles, and it is expected the application range of the virtual assistant will be further expanded.

However, speech can be volatile. Although short-term memory capacity of a person may differ among individuals, in general, the capacity is approximately two seconds long or five letters.

Furthermore, delivery of information by a speech-based interface is usually one-time. Visual information delivered via a screen can be freely checked at any time with little effort, but it is difficult to restore information once the information elapses in the speech-based interface.

According to a Deloitte survey of smartphone users in the United Kingdom in 2016, approximately 61% of users have never used a smartphone voice assistant service. The survey also found that 28% of users who use the voice assistant service mainly use the service for simple functions such as searching for information or navigation.

As described above, the speech-based interface has many advantages in terms of input of information rather than output of information such that the speech-based interface may be useful in special circumstances such as a user having limited finger input or driving.

However, during a user's everyday life, the user may want to frequently check past call history during a phone call. With regard to voice content, a service based on artificial intelligence that compensates for the disadvantages of voice information, which is easily volatile, may be provided by an artificial intelligence assistant.

Korean Unexamined Patent Application Publication No. 10-2019-0077820 discloses an application practicer, wherein an application and a time are selected for executing the selected application at the selected time. However, the related art has no distinct feature from an existing alarm function in that the related art is an alarm function added to the execution of the application.

Korean Unexamined Patent Application Publication No. 10-2019-0090078 discloses the providing of actionable content to a computing device based on user actions. The related art relates to contents accessed in a computing device of a user and usage of contents of an application executable in an additional but related computing device. However, according to the related art, only an effect of providing contents among computing devices can be achieved.

### RELATED ART DOCUMENTS

### Patent Document

Korean Unexamined Patent Application Publication No. 10-2019-0077820 (published on Jul. 4, 2019)

Korean Unexamined Patent Application Publication No. 10-2019-0090078 (published on Jul. 31, 2019)

### SUMMARY OF THE INVENTION

An objective of the present disclosure is to address the shortcoming of the scheduling of an execution time of a specific application.

An objective of the present disclosure is to address the shortcoming of volatile voice information by storing text of call data.

An objective of the present disclosure is to address the shortcoming of vulnerable storage space usage by selectively storing informative calls.

An objective of the present disclosure is to address the shortcoming of being unable to connect an application function which manages text information to voice information.

The objective of the present disclosure is not limited to the above-mentioned objectives and other objectives and aspects of the present disclosure which are not mentioned can be understood by the following description, and will be more clearly understood by the embodiments of the present disclosure. It is also to be understood that the aspects of the present disclosure may be realized by means and combinations thereof set forth in claims.

In order to achieve the above-described objectives, according to an aspect of the present disclosure, an action item suggesting method includes: converting call data into text to store a call transcript; extracting a keyword from at least one text information of the call transcript, a text message, or an e-mail, and by inferring a class to which the keyword belongs, suggesting an action item of an application corresponding to the class.

The converting call data into text may include recording a call to store the call data; and converting the call data, selected based on contact information and a recording time, into text and deleting call data that is not converted.

The converting call data into text may further include distinguishing and recognizing voices of a call sender and a call receiver by using the call data.

The converting call data into text may further include storing the call transcript so as to match a corresponding call in a call list.

The action item suggesting method may further include filtering spam information from the text information before the extracting a keyword.

The extracting a keyword may include extracting a keyword related to at least one of name and title of a person, date and time, a place name, a purpose, a method, or a reason, which correspond to 5W1H (who, what, when, where, why, how).

The extracting a keyword may include extracting a call subject through natural language processing and extracting the keyword based on the call subject.

The suggesting an action item may further include recommending a new application related to the call subject.

The action item suggesting method may further include using the keyword extracted from the call transcript as a training data set and storing a keyword classifying model trained to classify the keyword based on a feature of the keyword. Further, the suggesting an action item may further include suggesting an action item through the application corresponding to the class to which the keyword belongs by classifying the keyword using the keyword classifying model.

The action item suggesting method may further include retraining the keyword classifying model by using a training data set to which a weight is applied differently depending on a date, a day, and a time of the call and a call counterpart based on the data collected by a user terminal.

The action item suggesting method may further include retraining the keyword classifying model by using a training data set to which a weight is applied differently based on information that is given feedback depending on whether to execute the application in accordance with the suggestion of the action item, whether to detect a new recommended application, and whether to install the new application.

In order to achieve the above-described objectives, according to another aspect of the present disclosure, an action item suggesting device includes a keyword extracting engine configured to extract a keyword from at least one text information of the call transcript, a text message, or an e-mail; an action item suggesting engine configured to suggest an action item of an application corresponding to the class by inferring a class to which the keyword belongs; and a processor configured to control speech recognition for storing the call transcript, the keyword extracting engine, and the action item suggesting engine.

The processor may be configured to: control call recording for storing the call data; convert the call data, selected based on contact information and a recording time, into text; and delete call data that is not converted.

Further, the processor may be configured to distinguish a call sender and a call receiver by using call data in which the call recording is stored to control the speech recognition.

The action item suggesting device may further include a spam filter configured to filter spam information from the text information. The processor may be configured to control the spam filter which filters the spam information from the text information before extracting the keyword.

The processor may be configured to control the keyword extracting engine which extracts a keyword related to at least one of name and title of a person, date and time, a place name, a purpose, a method, or a reason, which correspond to 5W1H.

The processor may be configured to extract a call subject through natural language processing and control the keyword extracting engine which extracts the keyword based on the call subject.

The processor may be configured to control the action item suggesting engine which recommends a new application related to the call contents.

The action item suggesting engine may use a keyword extracted from the call transcript as a training data set and may use a keyword classifying model trained to classify a keyword based on the feature of the keyword, and the processor may be configured to control the keyword classifying model to classify the keywords and suggest an action item by an application corresponding to a class to which the keyword belongs.

The action item suggesting device may further include a learning processor configured to retrain the keyword classifying model through at least one of: training by using a training data set to which a weight is applied differently depending on a date, a day, or a time of the call and a call counterpart, based on data collected by the user terminal; and training by using a training data set to which a weight is applied differently based on information that is given feedback depending on whether to execute the application in accordance with the suggestion of the action item, whether to detect a new recommended application, and whether to install the new application.

In order to achieve the above-described objectives, according to an aspect of the present disclosure, a method comprises converting call data into text to store a call transcript; extracting a keyword from the call transcript; and suggesting an action item of an application by determining a class associated with the extracted keyword, wherein the application corresponds to the determined class.

Converting the call data into text further comprises recording a call in order to store the call data; and selecting the call data to be converted into text based on a contact information and a recording time associated with a call.

Converting the call data into text further comprises distinguishing between a first voice of a call sender and a second voice of a call receiver by using the call data.

Converting the call data into text further comprises storing the call transcript to be associated with a corresponding call in a call list.

The method further comprises filtering spam information from the call transcript before extracting the keyword from the call transcript.

The keyword is extracted based on at least one of: a name of a person, a title of the person, a date, a time, a place name, or a purpose of a call.

Extracting the keyword further comprises extracting a subject of the call data through natural language processing.

Suggesting the action item further comprises recommending a new application related to the subject of the call data, wherein the new application corresponds to an uninstalled application.

The method further comprises storing a keyword classifying model trained based on a feature of the extracted keyword, wherein the keyword classifying model is used to classify the extracted keyword in order to suggest the action item of the application corresponding to the determined class.

The method further comprises using the extracted keyword from the call transcript as a training data set; and retraining the keyword classifying model based on call information associated with the call data, wherein the call information corresponds to a date, a day, and a time of a call and a call counterpart and is collected by a user terminal.

The method further comprises using the extracted keyword from the call transcript as a training data set; and retraining the keyword classifying model based on using log data, wherein the log data refers to information regarding at least one of: whether to execute the application in accordance with the suggested action item, whether to detect a new recommended application, or whether to install a new recommended application.

In order to achieve the above-described objectives, according to another aspect of the present disclosure, a device comprises a keyword extracting engine configured to extract a keyword from a call transcript; an action item suggesting engine configured to suggest an action item of an application by determining a class associated with the extracted keyword, wherein the application corresponds to the determined class; and a processor configured to convert call data into text to store the call transcript, and control the keyword extracting engine and the action item suggesting engine.

The processor is further configured to record a call in order to store call data and select the call data to be converted into text based on a contact information and a recording time associated with the call.

The processor is further configured to distinguish between a first voice of a call sender and a second voice of a call receiver by using call data.

The device further comprises a spam filter configured to filter spam information from the call transcript, wherein the processor is further configured to control the spam filter configured to filter the spam information from the call transcript before extracting the keyword from the call transcript.

The processor is further configured to control the keyword extracting engine to extract a keyword based on at least one of: a name of a person, a title of the person, a date, a time, a place name, or a purpose.

The processor is further configured to control the keyword extracting engine to extract a subject of the call data through natural language processing.

The processor is further configured to control the action item suggesting engine to recommend a new application related to the subject of the call data, wherein the new application corresponds to an uninstalled application.

The action item suggesting engine is further configured to classify the extracted keyword based on a feature of the keyword, and wherein the processor is further configured to store a keyword classifying model trained based on a feature of the extracted keyword and classify the extracted keyword in order to suggest the action item of the application corresponding to the determined class.

The device further comprises a learning processor configured to use the extracted keyword from the call transcript as a training data set and retrain the keyword classifying model based on call information associated with the call data or log data, wherein the call information corresponds to a date, a day, and a time of a call and a call counterpart and is collected by a user terminal, wherein the log data refers to information regarding at least one of: whether to execute the application in accordance with the suggestion of the action item, whether to detect a new recommended application, or whether to install a new application.

According to the present disclosure, executing an application actively for managing selected voice information can be suggested to a user, rather than just scheduling the execution of the application.

Further, text of a call transcript is stored so that volatile voice information can be checked later.

Furthermore, informative calls are selected to be stored as text so that a storage space may be better utilized.

Furthermore, an application function which manages text information is connected to voice information so that an information management capability of an artificial intelligence assistant may be improved.

### BRIEF DESCRIPTION OF DRAWINGS

The above and other aspects, features, and advantages of the present disclosure will become apparent from the detailed description of the following aspects in conjunction with the accompanying drawings, in which:

FIG. 1 is an exemplary diagram of an action item suggestion according to an embodiment of the present disclosure;

FIG. 2 is an exemplary diagram of a network connected to an action item suggesting device according to an embodiment of the present disclosure;

FIG. 3 is a block diagram of an action item terminal according to an embodiment of the present disclosure;

FIG. 4 is a block diagram of a memory in FIG. 3;

FIG. 5 is a block diagram illustrating a relationship of modules;

FIG. 6 is a block diagram of a learning device according to an embodiment of the present disclosure;

FIG. 7 is a flowchart of an action item suggesting method according to an embodiment of the present disclosure;

FIG. 8 is a flowchart of a method for converting call data into text;

FIG. 9 is an exemplary diagram of voice processing according to an embodiment of the present disclosure;

FIG. 10 is a flowchart of a keyword extracting process according to an embodiment in FIG. 8;

FIG. 11 is a flowchart of a keyword extracting process according to an embodiment in FIG. 8;

FIG. 12 is a flowchart of a method for training an artificial intelligence model according to an embodiment of the present disclosure; and

FIG. 13 is a flowchart of a method for managing execution of an action item of the present disclosure.

### DETAILED DESCRIPTION

The embodiments disclosed in the present specification will be described in greater detail with reference to the accompanying drawings, and throughout the accompanying drawings, the same reference numerals are used to designate the same or similar components and redundant descriptions thereof are omitted. In the following description, the terms “module” and “unit” for referring to elements are assigned and used exchangeably in consideration of convenience of explanation, and thus, the terms per se do not necessarily have different meanings or functions. Wherever possible, the same reference numbers will be used throughout the drawings to refer to the same or like parts. In the following description, known functions or structures, which may confuse the substance of the present disclosure, are not explained. Further, the accompanying drawings are provided for more understanding of the embodiment disclosed in the present specification, but the technical spirit disclosed in the present disclosure is not limited by the accompanying drawings. It should be understood that all changes, equivalents, and alternatives included in the spirit and the technical scope of the present disclosure are included.

Although the terms first, second, third, and the like, may be used herein to describe various elements, components, regions, layers, and/or sections, these elements, components, regions, layers, and/or sections should not be limited by these terms. These terms are generally only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

An action item may refer to a unit of a documented event, task, activity, or action. The action item may refer to something that is created as a result of a meeting. An action item list may be created after the meeting to be shared by people who were involved with the meeting.

An action item suggesting device (hereinafter, simply referred to as a suggesting device), according to an embodiment of the present disclosure, relates to a device for suggesting a task, that is, an action item to be implemented by a user while an application serves as a main agent.

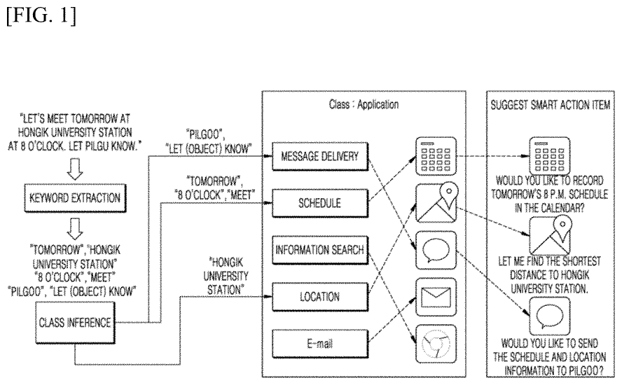

FIG. 1 is an exemplary diagram of an action item suggestion according to an embodiment of the present disclosure.

Referring to FIG. 1, an example of suggesting an action item or a smart action item, according to an embodiment of the present disclosure, is illustrated. The suggesting device may receive text as an input value. The inputted text may undergo several processes and be finally outputted as a suggestion of whether to drive the application for executing an action item.

Text to be inputted may be mainly obtained by converting a phone call conversation into text. When text is inputted, the suggesting device may extract a keyword from the text and classify the extracted text into classes. An application corresponding to the classified class may be selected, and whether to drive the selected application related to the action item implemented by the user may be suggested to the user.

For example, when a phone call conversation includes the text “Let's meet tomorrow at Hongik University Station at 8 o'clock. Let Pilgoo know,” the words “tomorrow,” “Hongik University,” “8 o'clock,” “meet,” “Pilgoo,” and “Let (object) know,” which correspond to keywords, may be extracted. The extracted keywords may be classified into classes. Examples of the classes, which include message delivery, schedule, information search, location, and e-mail, may be set in advance. The keywords may be classified as follows: “Pilgoo” and “Let (object) know” belonging to the class of message delivery; “tomorrow,” “8 o'clock,” and “meet” belonging to the class of schedule; and “Hongik University” belonging to the class of location. An application corresponding to each class may be selected, and the action item may be suggested by the application. Here, message delivery may correspond to a social networking service (SNS) application, schedule may correspond to a schedule management application, information search may correspond to a web browser, and e-mail may correspond to an e-mail application.

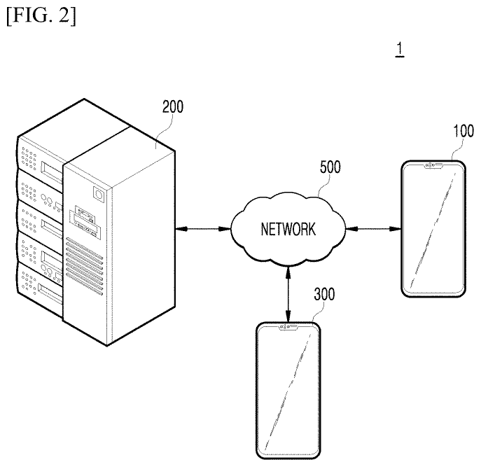

FIG. 2 is an exemplary diagram of a network connected to an action item suggesting device according to an embodiment of the present disclosure.

Referring to FIG. 2, two terminals 100 and 300 corresponding to an action item suggesting device 100, one or more servers 200, and a network 500 which connects the terminals and the servers for mutual communication are illustrated.

In some cases, the action item suggesting device 100, according to the embodiment of the present disclosure, may also be referred to as a mobile terminal 100. Hereinafter, the action item suggesting device 100, according to an embodiment of the present disclosure, will be described with the mobile terminal 100 being focused among various embodiments of the action item suggesting device 100. Unless other specific assumptions or conditions are provided, the description of the mobile terminal 100 may be applied to other types of communication terminals.

The action item suggesting device 100 and the terminal 300 may be used as phones of both parties having a phone call conversation. The terminal 300 is not limited to just a mobile phone but may include a corded telephone. The action item suggesting device 100 may store the phone call conversation with the terminal 300 as data, convert the stored data into text, infer a class related to a keyword extracted from the text, and drive the application related to the class to suggest an action item to the user. Here, the action item suggesting device 100 may communicate with the server 200 by using various methods.

The action item suggesting device 100 may handle the processes of converting text, extracting a keyword, and inferring a class by using an artificial intelligence (AI) algorithm.

AI is one field of computer science and information technology that studies methods to make computers mimic intelligent human behaviors such as reasoning, learning, self-improving and the like.

In addition, the artificial intelligence does not exist on its own, but is rather directly or indirectly related to a number of other fields in computer science. In recent years, there have been numerous attempts to introduce an element of the artificial intelligence into various fields of information technology to solve problems in the respective fields.

Machine learning is an area of artificial intelligence that includes the field of study that gives computers the capability to learn without being explicitly programmed.

Specifically, Machine Learning can be a technology for researching and constructing a system for learning, predicting, and improving its own performance based on empirical data and an algorithm for the same. The algorithms of the Machine Learning take a method of constructing a specific model in order to obtain the prediction or the determination based on the input data, rather than performing the strictly defined static program instructions.

Numerous machine learning algorithms have been developed for data classification in machine learning. Representative examples of such machine learning algorithms for data classification include a decision tree, a Bayesian network, a support vector machine (SVM), an artificial neural network (ANN), and so forth.

Decision tree refers to an analysis method that uses a tree-like graph or model of decision rules to perform classification and prediction.

Bayesian network may include a model that represents the probabilistic relationship (conditional independence) among a set of variables. Bayesian network may be appropriate for data mining via unsupervised learning.

SVM may include a supervised learning model for pattern detection and data analysis, heavily used in classification and regression analysis.

ANN is a data processing system modelled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

ANNs may refer generally to models that have artificial neurons (nodes) forming a network through synaptic interconnections, and acquires problem-solving capability as the strengths of synaptic interconnections are adjusted throughout training.

The terms “artificial neural network” and “neural network” may be used interchangeably herein.

An ANN may include a number of layers, each including a number of neurons. In addition, the Artificial Neural Network can include the synapse for connecting between neuron and neuron.

An ANN may be defined by the following three factors: (1) a connection pattern between neurons on different layers; (2) a learning process that updates synaptic weights; and (3) an activation function generating an output value from a weighted sum of inputs received from a lower layer.

ANNs include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN may be classified as a single-layer neural network or a multi-layer neural network, based on the number of layers therein.

A general Single-Layer Neural Network is composed of an input layer and an output layer.

In addition, a general Multi-Layer Neural Network is composed of an Input layer, one or more Hidden layers, and an Output layer.

The Input layer is a layer that accepts external data, the number of neurons in the Input layer is equal to the number of input variables, and the Hidden layer is disposed between the Input layer and the Output layer and receives a signal from the Input layer to extract the characteristics to transfer it to the Output layer. The Output layer receives a signal from the Hidden layer, and outputs an output value based on the received signal. The Input signal between neurons is multiplied by each connection strength (weight) and then summed, and if the sum is larger than the threshold of the neuron, the neuron is activated to output the output value obtained through the activation function.

Meanwhile, the Deep Neural Network including a plurality of Hidden layers between the Input layer and the Output layer can be a representative Artificial Neural Network that implements Deep Learning, which is a type of Machine Learning technology.

The Artificial Neural Network can be trained by using training data. Herein, the training can mean a process of determining a parameter of the Artificial Neural Network by using training data in order to achieve the objects such as classification, regression, clustering, etc. of input data. As a representative example of the parameter of the Artificial Neural Network, there can be a weight given to a synapse or a bias applied to a neuron.

The Artificial Neural Network trained by the training data can classify or cluster the input data according to the pattern of the input data.

Meanwhile, the Artificial Neural Network trained by using the training data can be referred to as a trained model in the present specification.

Next, the learning method of the Artificial Neural Network will be described.

The learning method of the Artificial Neural Network can be largely classified into Supervised Learning, Unsupervised Learning, Semi-supervised Learning, and Reinforcement Learning.

Supervised Learning is a method of the Machine Learning for inferring one function from the training data.

Then, among the thus inferred functions, outputting consecutive values is referred to as regression, and predicting and outputting a class of an input vector is referred to as classification.

In Supervised Learning, the Artificial Neural Network is learned in a state where a label for the training data has been given.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

In addition, in the present specification, setting the label to the training data for training of the Artificial Neural Network is referred to as labeling the labeling data on the training data.

Training data and labels corresponding to the training data together may form a single training set, and as such, they may be inputted to an artificial neural network as a training set.

Meanwhile, the training data represents a plurality of features, and the labeling the label on the training data can mean that the feature represented by the training data is labeled. In this case, the training data can represent the feature of the input object in the form of a vector.

The Artificial Neural Network can infer a function of the relationship between the training data and the labeling data by using the training data and the labeling data. Then, the parameter of the Artificial Neural Network can be determined (optimized) by evaluating the function inferred from the Artificial Neural Network.

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data based on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One of semi-supervised learning techniques involves guessing the label of unlabeled training data, and then using this guessed label for learning. This technique may be used advantageously when the cost associated with the labeling process is high.

Reinforcement learning may be based on a theory that given the condition under which a reinforcement learning agent can determine what action to choose at each time instance, the agent can find an optimal path to a solution solely based on experience without reference to data.

The Reinforcement Learning can be mainly performed by a Markov Decision Process (MDP).

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, the hyperparameters are set before learning, and model parameters can be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size, and may also include methods that increase optimization accuracy in SGD by adjusting the momentum and step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters can be set to optimal values that provide a stable learning rate and accuracy.

Further, the action item suggesting device 100 retrains the artificial intelligence model which is trained by a learning device 200 using personal data of a user, based on a transfer learning method. The action item suggesting device 100 may use various artificial intelligence application programs provided from the server 200 during a process of executing or retraining the artificial intelligence model.

The server 200 may be configured to include one or more servers providing the learning device 200 which trains an artificial intelligence model and various functions, such as a learning server training an artificial intelligence model, a file server providing various files related to the artificial intelligence model, a database server, a web server, an application server, and a cloud server. The server 200 may be referred to as the learning device 200 in some cases. The learning device 200 will be described in more detail below.

The network 500 may be a communication network including: wired and wireless networks, such as a local area network (LAN), a wide area network (WAN), the Internet, the Intranet, and the extranet; and a mobile network such as cellular network, a 3G network, an LTE network, a 5G network, a Wi-Fi network, an AD hoc network, and a combination thereof.

The network 500 may include a connection of network elements such as a hub, a bridge, a router, a switch, and a gateway. The network 500 may include one or more connected networks, such as multiple network environments, including a public network, such as the Internet, and a private network, such as a secure corporate private network. Access to the network 500 may be provided by one or more wired or wireless access networks.

The terminal 100 may transmit and receive data with the server 200, which is a learning device, through a 5G network. Specifically, the action item suggesting device 100 may perform data communication with the learning device 200 using at least one service of enhanced mobile broadband (eMBB), ultra-reliable and low latency communications (URLLC), or massive machine-type communications (mMTC) through the 5G network.

eMBB (enhanced mobile broadband) is a mobile broadband service, and multimedia contents, wireless data access, etc. are provided through eMBB (enhanced mobile broadband). Further, more improved mobile services such as a hotspot and a wideband coverage for receiving mobile traffic that are tremendously increasing can be provided through eMBB. Large traffic can be received to an area with little mobility and high density of users through a hotspot. A wide and stable wireless environment and user mobility can be secured by a wideband coverage.

A URLLC (ultra-reliable and low latency communications) service defines very severer requirements than existing LTE in terms of reliability in data transmission/reception and transmission delay, and 5G services for production process automation at industrial sites, telemedicine, telesurgery, transportation, safety, etc. are representative.

mMTC (massive machine-type communications) is a service that is not sensitive to transmission delay requiring a relatively small amount of data transmission. A large number of terminals more than common mobile phones such as sensors can simultaneously connect with a wireless access network by mMTC. In this case, the price of the communication module of a terminal should be low and a technology improved to increase power efficiency and save power is required to enable operation for several years without replacing or recharging a battery.

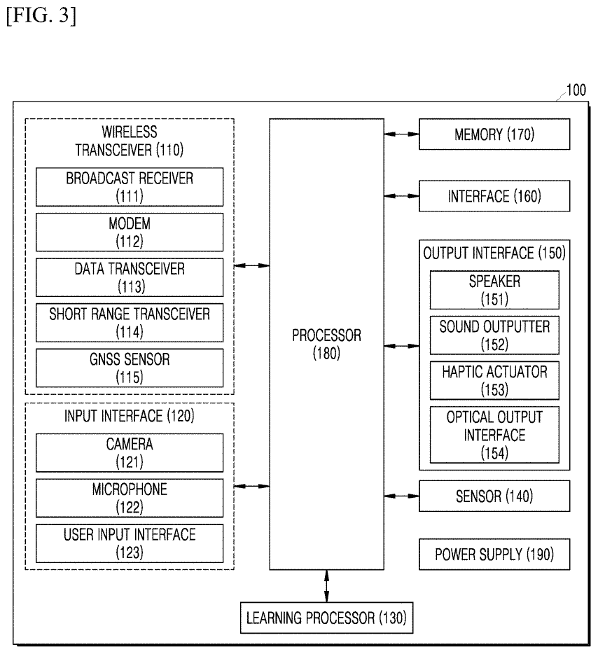

FIG. 3 is a block diagram of an action item terminal according to an embodiment of the present disclosure.

The terminal 100 may be implemented as a stationary terminal and a mobile terminal, such as a mobile phone, a projector, a mobile phone, a smartphone, a laptop computer, a terminal for digital broadcast, a personal digital assistant (PDA), a portable multimedia player (PMP), a navigation system, a slate PC, a tablet PC, an ultrabook, a wearable device (for example, a smartwatch, a smart glass, and a head mounted display (HMD)), a set-top box (STB), a digital multimedia broadcast (DMB) receiver, a radio, a laundry machine, a refrigerator, a desktop computer, a digital signage.

That is, the terminal 100 may be implemented as various home appliances used at home and also applied to a fixed or mobile robot.

The terminal 100 may perform a function of a voice agent. The voice agent may be a program which recognizes a voice of the user and outputs a response appropriate for the recognized voice of the user as a voice.

Referring to FIG. 3, the terminal 100 includes a wireless transceiver 110, an input interface 120, a learning processor 130, a sensor 140, an output interface 150, an interface 160, a memory 170, a processor 180, and a power supply 190.

A learning model (a trained model) may be loaded in the terminal 100.

In the meantime, the learning model may be implemented by hardware, software, or a combination of hardware and software. When a part or all of the learning model is implemented by software, one or more commands which configure the learning model may be stored in the memory 170.

The wireless transceiver 110 may include at least one of a broadcast receiver 111, a modem 112, a data transceiver 113, a short-range transceiver 114, or a global navigation satellite system (GNSS) sensor 115.

The broadcast receiver 111 receives a broadcasting signal and/or broadcasting related information from an external broadcasting management server through a broadcasting channel.

The modem 112 may transmit/receive a wireless signal to/from at least one of a base station, an external terminal, or a server on a mobile communication network established according to the technical standards or communication methods for mobile communication (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), and Long Term Evolution-Advanced (LTE-A)).

The data transceiver 113 refers to a module for wireless internet access and may be built in or external to the terminal 100. The data transceiver 113 may be configured to transmit/receive a wireless signal in a communication network according to wireless internet technologies.

The wireless Internet technologies may include Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A).

The short-range transceiver 114 may support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, or Wireless Universal Serial Bus (USB) technologies.

The GNSS sensor 115 is a module for obtaining the location (or the current location) of a mobile terminal, and its representative examples include a global positioning system (GPS) module or a Wi-Fi module. For example, the mobile terminal may obtain its position by using a signal transmitted from a GPS satellite through the GPS module.

The input interface 120 may include a camera 121 which inputs an image signal, a microphone 122 which receives an audio signal, and a user input interface 123 which receives information from the user.

Voice data or image data collected by the input interface 120 is analyzed to be processed as a control command of the user.

The input interface 120 may obtain training data for training a model and input data used to obtain an output using the trained model.

The input interface 120 may obtain input data which is not processed, and in this case, the processor 180 or the learning processor 130 pre-processes the obtained data to generate training data to be input to the model learning or pre-processed input data.

In this case, the pre-processing on the input data may refer to extracting of an input feature from the input data.

The input interface 120 is provided to input image information (or signal), audio information (or signal), data, or information input from the user and in order to input the image information, the terminal 100 may include one or a plurality of cameras 121.

The camera 121 processes an image frame such as a still image or a moving image obtained by an image sensor in a video call mode or a photographing mode. The processed image frame may be displayed on the display 151 or stored in the memory 170.

The microphone 122 processes an external sound signal as electrical voice data. The processed voice data may be utilized in various forms in accordance with a function which is being performed by the terminal 100 (or an application program which is being executed). In the microphone 122, various noise removal algorithms which remove a noise generated during the process of receiving the external sound signal may be implemented.

The user input interface 123 receives information from the user and when the information is input through the user input interface 123, the processor 180 may control the operation of the terminal 100 so as to correspond to the input information.

The user input interface 123 may include a mechanical input interface (or a mechanical key, for example, a button located on a front, rear, or side surface of the terminal 100, a dome switch, a jog wheel, or a jog switch) and a touch type input interface. For example, the touch type input interface may be formed by a virtual key, a soft key, or a visual key which is disposed on the touch screen through a software process or a touch key which is disposed on a portion other than the touch screen.

The learning processor 130 learns the model configured by an artificial neural network using the training data.

Specifically, the learning processor 130 repeatedly trains the artificial neural network using the aforementioned various learning techniques to determine optimized model parameters of the artificial neural network.

In this specification, the artificial neural network which is trained using training data to determine parameters may be referred to as a learning model or a trained model.

In this case, the learning model may be used to deduce a result for the new input data, rather than the training data.

The learning processor 130 may be configured to receive, classify, store, and output information to be used for data mining, data analysis, intelligent decision making, and machine learning algorithm and techniques.

The learning processor 130 may include one or more memory units configured to store data which is received, detected, sensed, generated, previously defined, or output by another component, device, the terminal, or a device which communicates with the terminal.

The learning processor 130 may include a memory which is combined with or implemented in the terminal. In some exemplary embodiments, the learning processor 130 may be implemented using the memory 170.

Selectively or additionally, the learning processor 130 may be implemented using a memory related to the terminal, such as an external memory which is directly coupled to the terminal or a memory maintained in the server which communicates with the terminal.

According to another exemplary embodiment, the learning processor 130 may be implemented using a memory maintained in a cloud computing environment or other remote memory locations accessible by the terminal via a communication method such as a network.

The learning processor 130 may be configured to store data in one or more databases to identify, index, categorize, manipulate, store, search, and output data in order to be used for supervised or non-supervised learning, data mining, predictive analysis, or used in the other machine. Here, the database may be implemented using the memory 170, a memory 230 of the learning device 200, a memory maintained in a cloud computing environment or other remote memory locations accessible by the terminal via a communication method such as a network.

Information stored in the learning processor 130 may be used by the processor 180 or one or more controllers of the terminal using an arbitrary one of different types of data analysis algorithms and machine learning algorithms.

As an example of such an algorithm, a k-nearest neighbor system, fuzzy logic (for example, possibility theory), a neural network, a Boltzmann machine, vector quantization, a pulse neural network, a support vector machine, a maximum margin classifier, hill climbing, an inductive logic system, a Bayesian network, (for example, a finite state machine, a Mealy machine, a Moore finite state machine), a classifier tree (for example, a perceptron tree, a support vector tree, a Markov Tree, a decision tree forest, an arbitrary forest), a reading model and system, artificial fusion, sensor fusion, image fusion, reinforcement learning, augmented reality, pattern recognition, automated planning, and the like, may be provided.

The processor 180 may determine or predict at least one executable operation of the terminal based on information which is determined or generated using the data analysis and the machine learning algorithm. To this end, the processor 180 may request, search, receive, or utilize the data of the learning processor 130 and control the terminal to execute a predicted operation or a desired operation among the at least one executable operation.

The processor 180 may perform various functions which implement intelligent emulation (that is, a knowledge based system, an inference system, and a knowledge acquisition system). This may be applied to various types of systems (for example, a fuzzy logic system) including an adaptive system, a machine learning system, and an artificial neural network.

The processor 180 may include sub modules which enable operations involving voice and natural language voice processing, such as an input and output (I/O) processing module, an environmental condition module, a speech to text (STT) processing module, a natural language processing module, a workflow processing module, and a service processing module.

The sub modules may have an access to one or more systems or data and a model, or a subset or a super set thoseof in the terminal. Further, each of the sub modules may provide various functions including a glossarial index, user data, a workflow model, a service model, and an automatic speech recognition (ASR) system.

According to another exemplary embodiment, another aspect of the processor 180 or the terminal may be implemented by the above-described sub module, a system, data, and a model.

In some exemplary embodiments, based on the data of the learning processor 130, the processor 180 may be configured to detect and sense requirements based on contextual conditions expressed by user input or natural language input or user's intention.

The processor 180 may actively derive and obtain information required to completely determine the requirement based on the contextual conditions or the user's intention. For example, the processor 180 may actively derive information required to determine the requirements, by analyzing past data including historical input and output, pattern matching, unambiguous words, and input intention.

The processor 180 may determine a task flow to execute a function responsive to the requirements based on the contextual condition or the user's intention.

The processor 180 may be configured to collect, sense, extract, detect and/or receive a signal or data which is used for data analysis and a machine learning task through one or more sensing components in the terminal, to collect information for processing and storing in the learning processor 130.

The information collection may include sensing information by a sensor, extracting of information stored in the memory 170, or receiving information from other equipment, an entity, or an external storage device through a transceiver.

The processor 180 collects usage history information from the terminal and stores the information in the memory 170.

The processor 180 may determine best matching to execute a specific function using stored usage history information and predictive modeling.

The processor 180 may receive or sense surrounding environment information or other information through the sensor 140.

The processor 180 may receive a broadcasting signal and/or broadcasting related information, a wireless signal, or wireless data through the wireless transceiver 110.

The processor 180 may receive image information (or a corresponding signal), audio information (or a corresponding signal), data, or user input information from the input interface 120.

The processor 180 may collect the information in real time, process or classify the information (for example, a knowledge graph, a command policy, a personalized database, or a conversation engine) and store the processed information in the memory 170 or the learning processor 130.

When the operation of the terminal is determined based on data analysis and a machine learning algorithm and technology, the processor 180 may control the components of the terminal to execute the determined operation. Further, the processor 180 may control the equipment in accordance with the control command to perform the determined operation.

When a specific operation is performed, the processor 180 analyzes history information indicating execution of the specific operation through the data analysis and the machine learning algorithm and technology and updates the information which is previously learned based on the analyzed information.

Therefore, the processor 180 may improve precision of a future performance of the data analysis and the machine learning algorithm and technology based on the updated information, together with the learning processor 130.

The sensor 140 may include one or more sensors which sense at least one of information in the mobile terminal, surrounding environment information around the mobile terminal, or user information.

For example, the sensor 140 may include at least one of a proximity sensor, an illumination sensor, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (for example, a camera 121), a microphone 122, a battery gauge, an environment sensor (for example, a barometer, a hygrometer, a thermometer, a radiation sensor, a thermal sensor, or a gas sensor), or a chemical sensor (for example, an electronic nose, a healthcare sensor, or a biometric sensor). On the other hand, the terminal 100 disclosed in the present disclosure may combine various kinds of information sensed by at least two of the above-mentioned sensors and may use the combined information.

The output interface 150 is intended to generate an output related to a visual, aural, or tactile stimulus and may include at least one of a display 151, an speaker 152, a haptic actuator 153, or an optical output interface 154.

The display 151 displays (outputs) information processed in the terminal 100. For example, the display 151 may display execution screen information of an application program driven in the terminal 100 and user interface (UI) and graphic user interface (GUI) information in accordance with the execution screen information.

The display 151 forms a mutual layered structure with a touch sensor or is formed integrally to be implemented as a touch screen. The touch screen may simultaneously serve as a user input interface 123 which provides an input interface between the terminal 100 and the user and provide an output interface between the terminal 100 and the user.

The speaker 152 may output audio data received from the wireless transceiver 110 or stored in the memory 170 in a call signal reception mode, a phone-call mode, a recording mode, a speech recognition mode, or a broadcasting reception mode.

The speaker 152 may include at least one of a receiver, a speaker, or a buzzer.

The haptic actuator 153 may generate various tactile effects that the user may feel. A representative example of the tactile effect generated by the haptic module 153 may be vibration.

The optical output interface 154 outputs a signal for notifying occurrence of an event using light of a light source of the terminal 100. Examples of the event generated in the terminal 100 may be message reception, call signal reception, missed call, alarm, schedule notification, email reception, and information reception through an application.

The interface 160 serves as a passage with various types of external devices which are connected to the terminal 100. The interface 160 may include at least one of a wired/wireless headset port, an external charger port, a wired/wireless data port, a memory card port, a port which connects a device equipped with an identification module, an audio I/O port, a video I/O port, or an earphone port. The terminal 100 may perform appropriate control related to the connected external device in accordance with the connection of the external device to the interface 160.

In the meantime, the identification module is a chip in which various information for authenticating a usage right of the terminal 100 is stored and includes a user identification module (UIM), a subscriber identify module (SIM), and a universal subscriber identity module (USIM). The device with an identification module (hereinafter, “identification device”) may be manufactured as a smart card. Therefore, the identification device may be connected to the terminal 100 through the interface 160.

The memory 170 stores data which supports various functions of the terminal 100.

The memory 170 may store various application programs (or applications) driven in the terminal 100, data for the operation of the terminal 100, commands, and data (for example, at least one algorithm information for machine learning) for the operation of the learning processor 130.

The memory 170 may store the model which is learned in the learning processor 130 or the learning device 200.

If necessary, the memory 170 may store the trained model by dividing the model into a plurality of versions depending on a training timing or a training progress.

In this case, the memory 170 may store input data obtained from the input interface 120, learning data (or training data) used for model learning, a learning history of the model, and so forth.

In this case, the input data stored in the memory 170 may be not only data which is processed to be suitable for the model learning but also input data itself which is not processed.

In addition to the operation related to the application program, the processor 180 may generally control an overall operation of the terminal 100. The processor 180 may process a signal, data, or information which is input or output through the above-described components or drives the application programs stored in the memory 170 to provide or process appropriate information or functions to the user.

Further, in order to drive the application program stored in the memory 170, the processor 180 may control at least some of components described with reference to FIG. 3. Moreover, the processor 180 may combine and operate at least two of components included in the terminal 100 to drive the application program.

In the meantime, as described above, the processor 180 may control an operation related to the application program and an overall operation of the terminal 100. For example, when the state of the terminal satisfies a predetermined condition, the processor 180 may execute or release a locking state which restricts an input of a control command of a user for the applications.

The power supply 190 is applied with external power or internal power to supply the power to the components included in the terminal 100 under the control of the processor 180. The power supply 190 includes a battery and the battery may be an embedded battery or a replaceable battery.

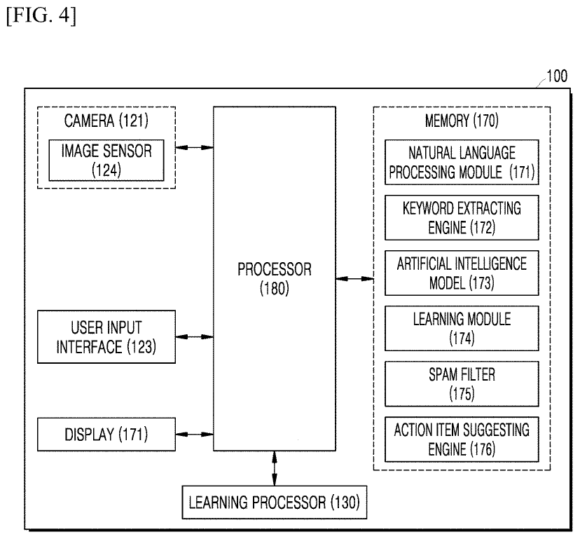

FIG. 4 is a block diagram of a memory in FIG. 3.

Referring to FIG. 4, components of the memory 170 included in the terminal 100 are schematically illustrated. In the memory 170, various computer program modules may be loaded. A natural language processing module 171, a keyword extracting engine 172, an artificial intelligence model 173, a learning module 174, a spam filter 175, and a smart action item engine 176, as application programs, may be included in the scope of the computer program loaded in the memory 170, as well as the operating system and a system program which manages hardware.

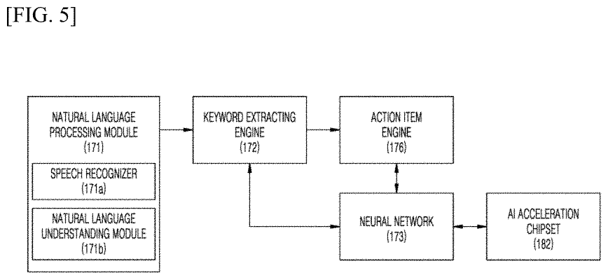

FIG. 5 is a block diagram illustrating a relationship of modules.

Referring to FIGS. 4 and 5, functions of: extracting a feature of a voice related to the natural language processing module 171; recognizing a voice by using a voice model, that is, a sound model, a pronunciation dictionary, and a language model; and understanding a natural language by using grammar, semantic information, and contextual information may be performed by various arithmetic functions of the processor 180.

A function of extracting a keyword related to the action item from a call transcript obtained by converting the call data related to the keyword extracting engine 172 into text may be performed by various arithmetic functions of the processor 180.

Functions of recognizing a voice, extracting a keyword, and inferring a class using a neural network based on machine learning or deep learning related to the artificial intelligence model 173 may be performed by various arithmetic functions of the processor 180.

A function of training and retraining a neural network based on machine learning or deep learning related to the learning model 174 may be performed by various arithmetic functions of the processor 180.

A function related to the spam filter 175 of filtering spam information from text information including a call transcript, a text message, and e-mail may be performed by various arithmetic functions of the processor 180.

Functions of suggesting an action item related to the smart action item engine 176, confirming whether to perform the suggested action item, and managing a history of the action item may be performed by various arithmetic functions of the processor 180.

The processor 180 may be configured to include one or more processors.

Referring to FIG. 5 again, an artificial intelligence (AI) acceleration chipset 182, which processes an operation related to the artificial intelligence algorithm, is illustrated. The artificial intelligence acceleration chipset may include arithmetic logic suitable for matrix operation processing of a feature vector including a feature of an image pixel value and a feature vector including a feature of the text. Specifically, the artificial intelligence acceleration chipset 182 may allow the terminal 100 to extract a keyword by controlling the keyword extracting engine 172 and the action item engine 176 by using a deep learning-based neural network 173 and extract a class corresponding to the action item, without the assistance of the server 200.

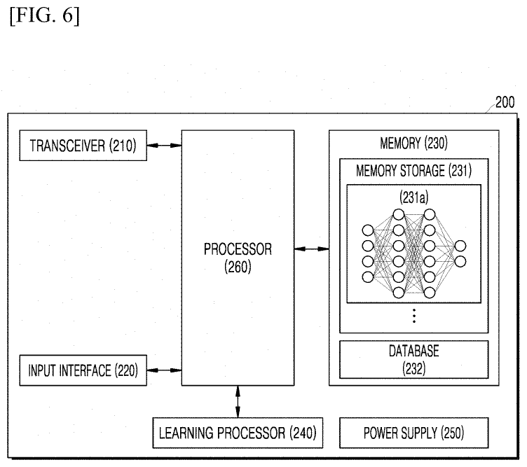

FIG. 6 is a block diagram of a learning device according to an embodiment of the present disclosure.

The learning device 200 is a device or a server which is separately configured at the outside of the terminal 100 and may perform the same function as the learning processor 130 of the terminal 100.

That is, the learning device 200 may be configured to receive, classify, store, and output information to be used for data mining, data analysis, intelligent decision making, and machine learning algorithms. Here, the machine learning algorithm may include a deep learning algorithm.

The learning device 200 may communicate with at least one terminal 100 and derive a result by analyzing or learning the data on behalf of the terminal 100. Here, the meaning of “on behalf of the other device” may be distribution of a computing power by means of distributed processing.

The learning device 200 of the artificial neural network is various devices for learning an artificial neural network and normally, refers to a server, and also referred to as a learning device or a learning server.

Specifically, the learning device 200 may be implemented not only by a single server, but also by a plurality of server sets, a cloud server, or a combination thereof.

That is, the learning device 200 is configured as a plurality of learning devices to configure a learning device set (or a cloud server) and at least one learning device 200 included in the learning device set may derive a result by analyzing or learning the data through the distributed processing.

The learning device 200 may transmit a model trained by the machine learning or the deep learning to the terminal 100 periodically or upon the request.

Referring to FIG. 6, the learning device 200 may include a transceiver 210, an input interface 220, the memory 230, a learning processor 240, a power supply 250, and a processor 260.

The transceiver 210 may correspond to a configuration including the wireless transceiver 110 and the interface 160 of FIG. 3. That is, the transceiver may transmit and receive data with the other device through wired/wireless communication or an interface.

The input interface 220 is a configuration corresponding to the input interface 120 of FIG. 3 and may receive the data through the transceiver 210 to obtain data.

The input interface 220 may obtain input data for acquiring an output using training data for model learning and a trained model.

The input interface 220 may obtain input data which is not processed, and, in this case, the processor 260 may pre-process the obtained data to generate training data to be input to the model learning or pre-processed input data.

In this case, the pre-processing on the input data performed by the input interface 220 may refer to extracting of an input feature from the input data.

The memory 230 is a configuration corresponding to the memory 170 of FIG. 3.

The memory 230 may include a memory storage 231, a database 232, and so forth.

The memory storage 231 stores a model (or an artificial neural network 231a) which is learning or trained through the learning processor 240, and when the model is updated through the learning/training, the memory storage 231 stores the updated model.

If necessary, the memory storage 231 stores the trained model by dividing the model into a plurality of versions depending on a training timing or a training progress.

The artificial neural network 231a illustrated in FIG. 6 is one example of artificial neural networks including a plurality of hidden layers but the artificial neural network of the present disclosure is not limited thereto.

The artificial neural network 231a may be implemented by hardware, software, or a combination of hardware and software. When a part or all of the artificial neural network 231a is implemented by the software, one or more commands which configure the artificial neural network 231a may be stored in the memory 230.

The database 232 stores input data obtained from the input interface 220, learning data (or training data) used to learn a model, a learning history of the model, and so forth.

The input data stored in the database 232 may be not only data which is processed to be suitable for the model learning but also input data itself which is not processed.

The learning processor 240 is a configuration corresponding to the learning processor 130 of FIG. 3.

The learning processor 240 may train (or learn) the artificial neural network 231a using training data or a training set.

The learning processor 240 may immediately obtain data which is obtained by pre-processing input data obtained by the processor 260 through the input interface 220 to learn the artificial neural network 231a or obtain the pre-processed input data stored in the database 232 to learn the artificial neural network 231a.

Specifically, the learning processor 240 repeatedly may train the artificial neural network 231a using various learning techniques described above to determine optimized model parameters of the artificial neural network 231a.

In this specification, the artificial neural network which is trained using training data to determine parameters may be referred to as a learning model or a trained model.

In this case, the learning model may be loaded in the learning device 200 to deduce the result value or may be transmitted to the other device such as the terminal 100 through the transceiver 210 to be loaded.

Further, when the learning model is updated, the updated learning model may be transmitted to the other device such as the terminal 100 via the transceiver 210 to be loaded.

The power supply 250 is a configuration corresponding to the power supply 190 of FIG. 3.

A redundant description for corresponding configurations will be omitted.

In addition, the learning device 200 may evaluate the artificial intelligence model 231a and update the artificial intelligence model 231a for better performance even after the evaluation and provide the updated artificial intelligence model 231a to the terminal 100. Here, the terminal 100 may perform a series of steps performed by the learning device 200 solely in a local area or together with the learning device 200 through the communication with the learning device 200. For example, the terminal 100 allows the artificial intelligence model 173 in a local area to learn a personal pattern of the user through a second learning using the user's personal data to update the artificial intelligence model 173, which is downloaded from the learning device 200.

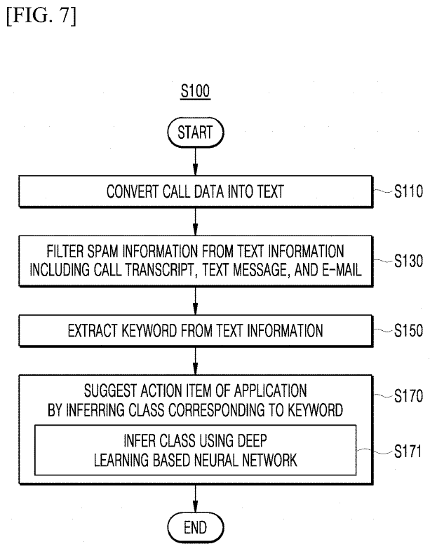

FIG. 7 is a flowchart of an action item suggesting method according to an embodiment of the present disclosure.

Referring to FIG. 7, the processor 180 may convert call data stored in the terminal 100 into text for storing a call transcript in step S110. The processor 180 needs to generate input data to extract a keyword and a class to which the keyword belongs. Data inputted to extract a keyword is call data obtained by recording the call conversation, that is, text data converted from a binary file.

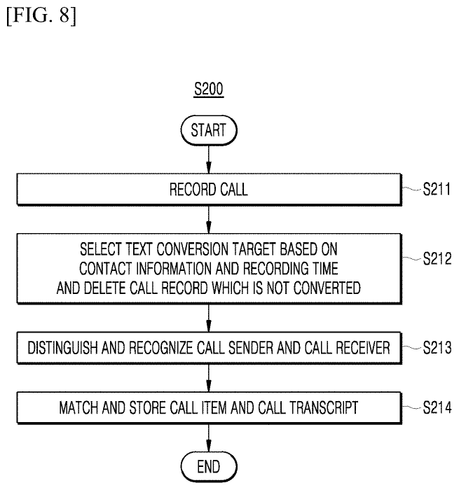

FIG. 8 is a flowchart of a method for converting call data into text.

Referring to FIG. 8, the process of converting the call data into text (S200) may be configured to include recording a call (S211), selecting a target to be converted into text (S212), recognizing a voice (S213), and storing a text (S214).

The processor 180 may convert a call sound into a voice signal by using the microphone 122 and store the converted voice signal in the memory 170 as binary data. Voice data of the call stored in the memory 170 will be referred to as call data.

The processor 180 may select a text converting target from the call data stored to efficiently manage a storage space of the memory 170 and control the memory 170 to delete call data that is not converted after converting the selected call data into text in step S212.

Before converting the call data into text, the processor 180 may select call data to be converted into text, based on a property of the call data. Here, the property of the call data may include whether the call is an incoming call or an outgoing call, a call counterpart, and the duration of the call. Therefore, the processor 180 may select call data to be converted into text, based on whether the call is an incoming call or an outgoing call, contact information, and a recording time.

For example, the processor 180 may exclude a call having a length which is less than or equal to a threshold time, from among incoming calls, from the target to be converted into text. Furthermore, the processor 180 may select call data with a counterpart, included in the contact information stored in the terminal 100, as a target to be converted into text. Even though the call data excluded from the target to be converted into text is not immediately deleted, the call data is deleted by overwriting call data which is additionally stored.

The processor 180 may convert the selected call data into text information, that is, a call transcript. A process of converting call data into text information corresponds to a speech recognition process. The speech recognition process requires various algorithms and requests a large amount of data so that the processor 180 may use a speech recognition function performed by the server 200 including a speech recognizer.

The speech recognition may also be represented by speech-to-text (STT) denoting conversion of a speech into text. A hidden Markov model, which is a representative speech recognition algorithm, may statistically model speech uttered by various speakers to construct a sound model and collect a corpus to construct a language model, and convert the call into text by using the sound model, the language model, and the pronunciation dictionary. A speech algorithm available in the embodiment of the present disclosure is not limited to the HMM. The processor 180 may recognize the call conversation by using various types of artificial intelligence algorithms, for example, a machine learning or deep learning-based neural network, such as a convolutional neural network (CNN), a deep neural network (DNN), and a recurrent neural network (RNN).

When a keyword is extracted and a class is extracted based on the keyword, it is necessary to distinguish whether various information included in the call transcript is from a sender or a receiver. Therefore, the processor 180 needs to distinguish and recognize voices of a call sender and a call receiver.

The processor 180 may distinguish and recognize the voices of a user who carries the terminal 100 and a counterpart caller based on a difference in volume level, even without having a complex process of distinguishing tones in step S213. The voice of the user may be collected by a microphone without amplifying the voice, and the voice of the counterpart is amplified from a received signal so that it is possible to distinguish whether the stored data is the user's data or the counterpart's data, depending on a call volume level.

The processor 180 may match and store the call item and the call transcript in step S214. The processor 180 may perform a function of managing the call through an application. The call transcript may include information of whether it is an incoming call or an outgoing call, call duration, and a time of the call. The processor 180 may store the call transcript by using an application having a call management function.

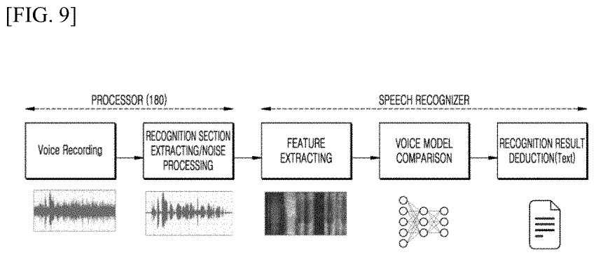

FIG. 9 is an exemplary diagram of voice processing according to an embodiment of the present disclosure.

Referring to FIG. 9, a voice processing process of converting call conversation into text is illustrated. The voice processing process may be configured to include a call recording process, a call data pre-processing process, and a call voice recognizing process. The call voice recognizing process may be configured to include extracting a feature of a voice signal, comparing a feature of the extracted voice signal and a voice model, and deducing text by speech recognition. The call recording and the call data pre-processing processes may be performed by the processor 180.

The pre-processing may include extracting a recognized section and noise processing. The call voice is recognized by a speech recognizer and the processor 180 may control an input and an output of the server 200 including the speech recognizer or directly control the speech recognizer stored in the terminal 100.

In the embodiment of the present disclosure, the scope of the text information used to extract a keyword and extract an action item to which the keyword belongs is not limited to the call transcript. That is, a message which is transmitted and received by a messenger function of the terminal 100 and text information of an e-mail which is transmitted and received may be included in the scope.

Referring to FIG. 7 again, the processor 180 may filter the spam information from among the entire text information which is received and transmitted through the terminal 100 by using the spam filter in step S130. The processor 180 may use a spam filter function provided by an e-mail client on the text information of the e-mail. Further, the processor 180 may filter the spam information from the text information of the call transcript and the message by using a spam filter provided from the server 200 or the spam filter stored in the memory 170.

The processor 180 may extract a keyword based on the text information recognized through speech recognition based on call data including call conversation in step S150. The processor may infer a class corresponding to the extracted keyword and suggest an action item of an application corresponding to the inferred class in step S170.

The extracting a keyword and the inferring of a class to which the keyword belongs are related to the text classification in the natural language processing. According to the text classification, one sentence or one document is understood and analyzed, and the sentence or the document is classified based on the analysis.

Text classification is a process of receiving text as an input and identifying the type of class to which the text belongs. According to the spam mail classification, two classes of general mail and spam mail are determined to classify the input texts into one of two classes.

When there are two classes to be classified in the text classification, the text classification is referred to as binary classification, and when there are three or more classes, the text classification is referred to as multi-class classification. The spam mail classification with two classes of general mail and spam mail corresponds to the binary classification.

In addition to the spam mail classification, there are classification problems such as emotion analysis, which receives text such as a movie review for classifying the review into a positive review or a negative review, and intention analysis, which classifies an intention of the user, based on inputted text, into classes of a question, a command, and a rejection.

The processor 180 extracts a keyword from text information and infers a class from the extracted keyword by using various keyword extracting and class inferring methods. Furthermore, among various keyword extracting and class inferring methods, some methods may include natural language understanding and other methods may not include natural language understanding. In addition, the keyword extracting and class inferring methods including natural language understanding may include a method using an artificial intelligence algorithm such as a convolutional neural network or a recurrent neural network and a statistical method such as N-gram. In the embodiment of the present disclosure, the methods are combined to be used to extract a keyword. For example, the processor 180 stores a similar history while basically using the N-gram used for natural language processing to extract a keyword and additionally uses a neural network language model to classify the stored information in accordance with a predetermined pattern.

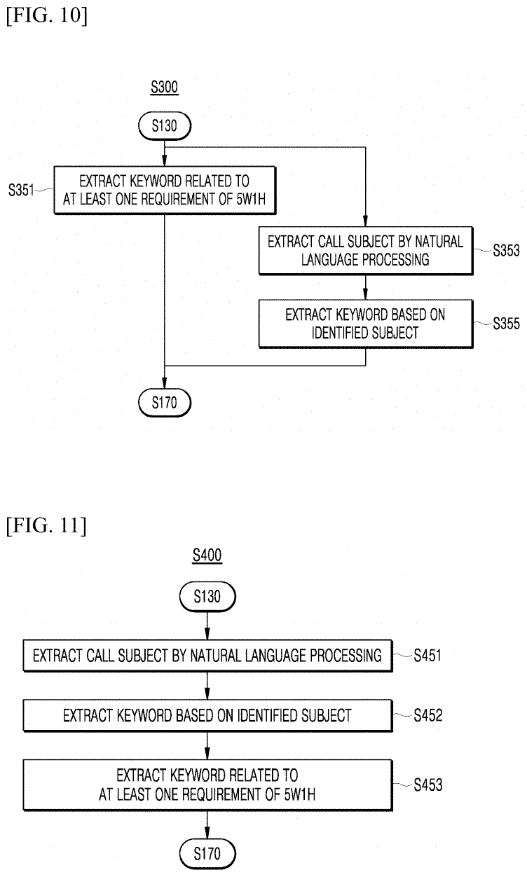

FIG. 10 is a flowchart of a keyword extracting process according to an embodiment in FIG. 8.

Referring to FIG. 10, the processor 180 may extract a keyword from extracted text information by using any one of two methods.

A first keyword extracting method is to extract a keyword related to at least one requirement of 5W1H from the text information which is inputted without performing the natural language understanding process in step S351. The processor 180 of the terminal 100 may extract a keyword based on text information inputted without performing the natural language processing by the server 200, which requires a lot of operations.

A second keyword extracting method is to extract a subject by performing the natural language processing on the input text information in step S353 and extract a keyword based on the extracted subject in step S355. The accuracy of inferring the class may be increased by understanding a sentence based on the keyword before inferring the class.

FIG. 11 is a flowchart of a keyword extracting process according to an embodiment in FIG. 8.

Referring to FIG. 11, the processor 180 uses the two abovementioned methods to extract a subject of the call through the natural language processing in step S451, extract a keyword based on the extracted subject in step S452, and extract a keyword related to at least one requirement of 5W1H. The processor 180 may process a natural language by using various algorithms provided by the server 200, a classifier, and a database.

The two methods may be mainly used as the action item suggesting method by using an artificial intelligence model according to an embodiment of the present disclosure. One of the methods trains the artificial intelligence model and the other method uses an artificial intelligence model which has already been trained.

A basic training of the artificial intelligence model, for example, the training of a deep network requires a process of collecting very massive training datasets to which labels are designated and a process of designing a network architecture to train a feature and complete a model. Even though an excellent result may be obtained through deep network training, this approach requires a huge amount of training datasets, and a layer and a weight need to be set to a network to be used, such as CNN.

A transfer learning method, which is a process including a method of delicately adjusting a pre-trained model, may be used for a plurality of artificial intelligence application programs used for a pre-trained artificial intelligence model. For example, according to this transfer learning method, new data including a class which has not been known in the related art may be injected into a deep network by using an existing network such as AlexNet or GoogLeNet.

When the transfer method is used, the artificial intelligence model is trained in advance with a large amount of text data so that the time may be saved, and the result may be quickly produced.

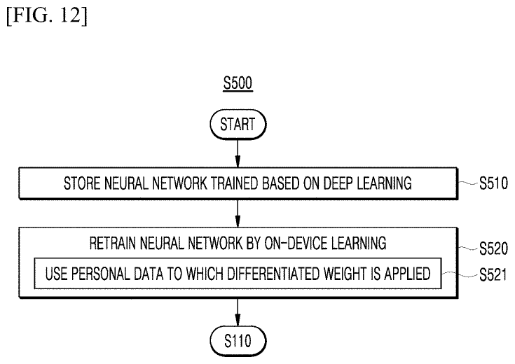

FIG. 12 is a flowchart of a method for training an artificial intelligence model according to an embodiment of the present disclosure.

Referring to FIG. 12, the action item suggesting method S110, according to an embodiment of the present disclosure, may be configured to further include a step S510 of storing an artificial intelligence model, which is trained in advance through learning of a class inference, by using a big-data-based training data set. The processor 180 may infer the class from the keyword by using the artificial intelligence model stored in the terminal 100.

Furthermore, the processor 180 may train the artificial intelligence model again in step S520 through on-device learning by using log data referring to at least one of whether to execute an application related to suggestion of an action item corresponding to an inferred class, whether to detect a new recommended application, whether to install the new application, or score management of an action item when the application is executed. The retraining of the artificial intelligence model through the on-device learning may be performed by the learning processor 130.

In addition, the processor 180 may retrain the artificial intelligence model through on-device learning by using at least one of the call transcript, a date and a day of when the text message and the e-mail-related information were received, or personal data applied with a weight differentiated depending on a call counterpart in step S521.

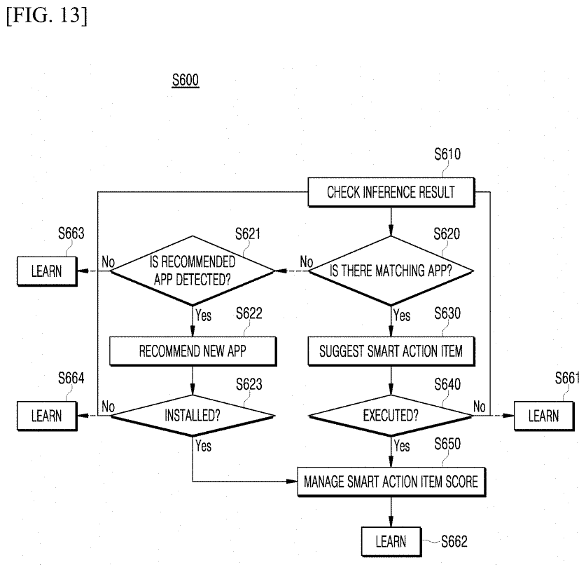

FIG. 13 is a flowchart of a method for managing execution of an action item of the present disclosure.

Referring to FIG. 13, a process of suggesting an action item by an application in accordance with a class inference result is illustrated in step S600.

The processor 180 checks a keyword-based class inference result in step S610.

The processor 180 may determine whether an application matched to the class is installed in the terminal 100 in step S620.

When the application corresponding to the inferred class is installed in the terminal, the processor 180 suggests an action item by using the installed application in step S630. According to the smart action item suggestion using the application, the user may accept or reject the suggestion.

The processor 180 may determine whether to execute the application depending on whether the user accepts the suggestion in step S640.

When the application is executed by the user, the processor 180 may manage a score of the smart action item using the application in step S650.

When the application matched to the inferred class is not installed in the terminal 100, the processor 180 may detect a recommended application matched to the inferred class in step S621, and when the detection is successful, may recommend the new application to the user in step S622. The processor 180 may determine whether the user installs the new application and manage the smart action item score by using the determination result in step S650.

The processor 180 may perform learning during the process of managing a score of the smart action item. For example, when the application in accordance with the suggestion of the smart action item is executed in step S662, or when the application is not executed in step S661, or when the recommended application is not detected in step S663, or when the new application is installed in step S662 or is not installed in step S664, the processor 180 may learn the results and manage the smart action item score in accordance with the learning.

According to the embodiment of the present disclosure, actively executing an application for selectively managing voice information may be suggested to a user, rather than just scheduling the execution of the application.

In addition, text of the call transcript is stored such that volatile voice information can be checked later.

Furthermore, informative calls are selected to be stored as text so that a storage space may be better utilized.

An application function which manages text information is connected to voice information so that an information management capability of an artificial intelligence assistant may be improved.

Embodiments according to the present disclosure described above may be implemented in the form of computer programs that may be executed through various components on a computer, and such computer programs may be recorded in a computer-readable medium. Examples of the computer-readable media include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program codes, such as ROM, RAM, and flash memory devices.

Meanwhile, the computer programs may be those specially designed and constructed for the purposes of the present disclosure or they may be of the kind well known and available to those skilled in the computer software arts. Examples of program code include both machine codes, such as produced by a compiler, and higher level code that may be executed by the computer using an interpreter.

The singular forms “a,” “an,” and “the” in this present disclosure, in particular, claims, may be intended to include the plural forms as well. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

Operations constituting the method of the present disclosure may be performed in appropriate order unless explicitly described in terms of order or described to the contrary. The present disclosure is not necessarily limited to the order of operations given in the description. All examples described herein or the terms indicative thereof (“for example,” etc.) used herein are merely to describe the present disclosure in greater detail. Therefore, it should be understood that the scope of the present disclosure is not limited to the example embodiments described above or by the use of such terms unless limited by the appended claims. Therefore, it should be understood that the scope of the present disclosure is not limited to the example embodiments described above or by the use of such terms unless limited by the appended claims. Also, it should be apparent to those skilled in the art that various alterations, substitutions, and modifications may be made within the scope of the appended claims or equivalents thereof.

Therefore, technical ideas of the present disclosure are not limited to the above-mentioned embodiments, and it is intended that not only the appended claims, but also all changes equivalent to claims, should be considered to fall within the scope of the present disclosure.

1. A method, comprising:
converting, by an action item suggesting device, call data of a phone call into text to store a call transcript after the phone call is over;
extracting, by the action item suggesting device, a keyword from the stored call transcript of the phone call after the phone call is over; and
suggesting, by the action item suggesting device, an action item of an application after the phone call is over by determining a class associated with the extracted keyword, wherein the application corresponds to the determined class.

2. The method of claim 1, wherein converting the call data into text further comprises:
recording a call in order to store the call data; and
selecting the call data to be converted into text based on a contact information and a recording time associated with a call.

3. The method of claim 1, wherein converting the call data into text further comprises distinguishing between a first voice of a call sender and a second voice of a call receiver by using the call data.

4. The method of claim 1, wherein converting the call data into text further comprises storing the call transcript to be associated with a corresponding call in a call list.

5. The method of claim 1, further comprising filtering spam information from the call transcript before extracting the keyword from the call transcript.

6. The method of claim 1, wherein the keyword is extracted based on at least one of: a name of a person, a title of the person, a date, a time, a place name, or a purpose of a call.

7. The method of claim 1, wherein extracting the keyword further comprises extracting a subject of the call data through natural language processing.

8. The method of claim 7, wherein suggesting the action item further comprises recommending a new application related to the subject of the call data, wherein the new application corresponds to an uninstalled application.

9. The method of claim 1, further comprising storing a keyword classifying model trained based on a feature of the extracted keyword, wherein the keyword classifying model is used to classify the extracted keyword in order to suggest the action item of the application corresponding to the determined class.

10. The method of claim 9, further comprising:
using the extracted keyword from the call transcript as a training data set; and
retraining the keyword classifying model based on call information associated with the call data, wherein the call information corresponds to a date, a day, and a time of a call and a call counterpart and is collected by a user terminal.

11. The method of claim 9, further comprising:
using the extracted keyword from the call transcript as a training data set; and
retraining the keyword classifying model based on using log data, wherein the log data refers to information regarding at least one of: whether to execute the application in accordance with the suggested action item, whether to detect a new recommended application, or whether to install a new recommended application.

12. A device, comprising:
a keyword extracting engine configured to extract a keyword from a call transcript;
an action item suggesting engine configured to suggest an action item of an application after a phone call is over by determining a class associated with the extracted keyword, wherein the application corresponds to the determined class; and
a processor configured to convert call data of the phone call into text to store the call transcript after the phone call is over, and control the keyword extracting engine and the action item suggesting engine.

13. The device according to claim 12, wherein the processor is further configured to record a call in order to store call data and select the call data to be converted into text based on a contact information and a recording time associated with the call.

14. The device according to claim 12, wherein the processor is further configured to distinguish between a first voice of a call sender and a second voice of a call receiver by using call data.

15. The device according to claim 12, further comprising a spam filter configured to filter spam information from the call transcript, wherein the processor is further configured to control the spam filter configured to filter the spam information from the call transcript before extracting the keyword from the call transcript.

16. The device according to claim 12, wherein the processor is further configured to control the keyword extracting engine to extract a keyword based on at least one of: a name of a person, a title of the person, a date, a time, a place name, or a purpose.

17. The device according to claim 12, wherein the processor is further configured to control the keyword extracting engine to extract a subject of the call data through natural language processing.

18. The device according to claim 17, wherein the processor is further configured to control the action item suggesting engine to recommend a new application related to the subject of the call data, wherein the new application corresponds to an uninstalled application.

19. The device according to claim 12, wherein the action item suggesting engine is further configured to classify the extracted keyword based on a feature of the keyword, and wherein the processor is further configured to store a keyword classifying model trained based on a feature of the extracted keyword and classify the extracted keyword in order to suggest the action item of the application corresponding to the determined class.

20. The device according to claim 19, further comprising:
a learning processor configured to use the extracted keyword from the call transcript as a training data set and retrain the keyword classifying model based on call information associated with the call data or log data, wherein the call information corresponds to a date, a day, and a time of a call and a call counterpart and is collected by a user terminal, wherein the log data refers to information regarding at least one of: whether to execute the application in accordance with the suggestion of the action item, whether to detect a new recommended application, or whether to install a new application.
